(19) United States
(12) Patent Application Publication
(10) Pub. No.: US 2015/0193259 A1
(43) Pub. Date: Jul. 9, 2015

(54) BOOSTING THE OPERATING POINT OF A PROCESSING DEVICE FOR NEW USER ACTIVITIES

(71) Applicant: Advanced Micro Devices, Inc., Sunnyvale, CA (US)

(72) Inventors: Ashish Jain, Austin, TX (US); Alexander J. Branover, Chestnut Hill, MA (US)

(73) Assignee: Advanced Micro Devices, Inc., Sunnyvale, CA (US)

(21) Appl. No.: 14/147,470

(22) Filed: Jan. 3, 2014

(51) Int. Cl. G06F 9/46

(52) U.S. Cl. CPC G06F 9/46

(57) ABSTRACT

A processing system detects user activities on one or more processing units. In response, an operating point (operating frequency or an operating voltage) of the processing unit handing the user activity is increased at the processing unit. Battery power may be conserved in some processing systems by limiting the increase in the operating point to a time interval and reducing the operating frequency or the operating voltage to a previous value after the time interval has elapsed.

### BACKGROUND

1. Field of the Disclosure

The present disclosure relates generally to processing devices and, more particularly, to power management states in processing devices.

2. Description of the Related Art

A user's perception of the performance of a processing device, such as a central processing unit (CPU), a graphics processing unit (GPU), or an accelerated processing unit (APU), may be strongly influenced by the time it takes the processing device to respond to actions performed by the user. Many user activities spawn a new process to be performed by a processing unit in the processing device. The current operational state of the processing unit or the processing device may lead to perceived delays. For example, the user may judge the performance of a processing device based upon the time it takes for a program to launch following a user activity, e.g., the time that elapses between the user double-clicking on an icon to launch the program and the program becoming visibly functional.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing device in accordance with some embodiments.

FIG. 2 is a plot of an operating frequency of a processing unit as a function of time according to some embodiments.

FIG. 3 is a flow diagram of a method for boosting a processing unit during a predetermined boost time interval according to some embodiments.

FIG. 4 is a flow diagram of a method for boosting a processing unit during a dynamically determined boost time interval according to some embodiments.

FIG. 5 is a flow diagram illustrating a method for designing and fabricating an integrated circuit device implementing at least a portion of a component of a processing device in accordance with some embodiments.

### DETAILED DESCRIPTION

As discussed herein, a user's perception of the performance level of a processing device may be strongly influenced by the response time of the processing device. For example, the user may perceive the processing device to be operating at a low performance level if the user notices significant delays in launching programs following an activity performed by the user to initiate the program. User activities may include double-clicking on an icon to launch a program, entering a command at a command prompt, switching active windows on a display, starting an instant messaging session, and the like. The user's perception of the performance of a processing device can therefore be enhanced by boosting one or more processing units in the processing device in response to an indication of a new user activity. For example, a processing unit such as a central processing unit (CPU), a graphics processing unit (GPU), or an accelerated processing unit (APU) in the processing system may be boosted by increasing the operating point of the processing unit by increasing the operating frequency or operating voltage of the processing unit. Users are often very sensitive to delays caused by the launch time of a new process and so boosting the processing units to speed the launch of the new process can noticeably improve the user's experience.

Some embodiments of the processing device may detect a new user activity using a hardware-based trigger. For example, the transition of a processing unit from an idle state in which the processing unit is not performing any tasks to an active state in which the processing unit is performing tasks may indicate the start of a new user activity. Background processes may also cause the processing unit to transition from the idle state to the active state and so some embodiments may filter out periodic interrupts or interrupts that occur more frequently than a threshold frequency. Some embodiments of the processing device may detect the new user activity using a software-based trigger. For example, the Windows® operating system generates notifications in response to the launch of new processes. For another example, changes the context associated with a display driver may indicate that a user is active and has begun a new activity such as switching from one window/application that is displayed on the screen to a different window/application that is displayed on the screen.

Battery power may also be conserved by limiting the boost to time intervals that correspond to the new user activity. For example, many processing devices such as laptops, tablets, or smart phones can operate in an alternating current (AC) mode, e.g. when the processing device is plugged into a wall outlet, or a direct current (DC) mode, e.g. when the processing device is unplugged and operating on an internal battery supply. Processing devices that are operating in the AC mode are conventionally optimized to enhance performance and processing devices that are operating in the DC mode are conventionally optimized to conserve power. Consequently, performance optimizations are not typically available while the processing system is operating in the DC mode. For example, boosting of the CPU or GPU may be disabled to conserve power and extend battery life while in the DC mode. However, boosting one or more processing units during a limited time interval following a new user action may significantly improve the user's perception of the performance of the processing device without consuming an excessive amount of battery power.

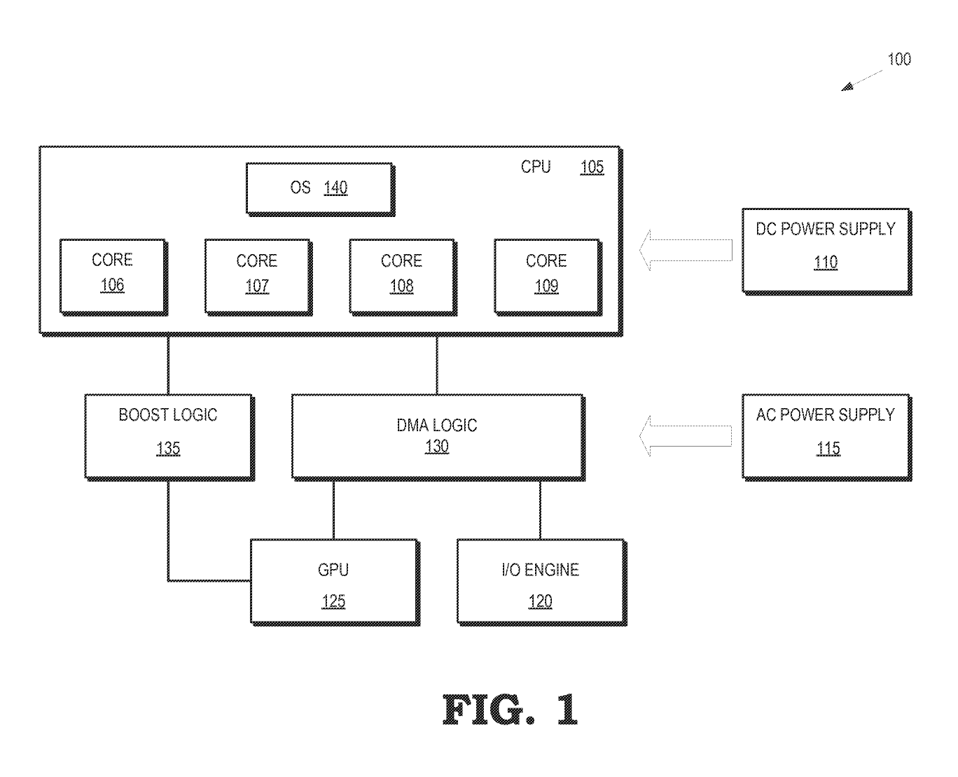

FIG. 1 is a block diagram of a processing device 100 in accordance with some embodiments. The processing system 100 includes a central processing unit (CPU) 105 for executing instructions. Some embodiments of the CPU 105 include multiple processor cores 106, 107, 108, 109 (collectively referred to hereinafter as the “processor cores 106-109”) that can independently execute instructions concurrently or in parallel. The CPU 105 shown in FIG. 1 includes four processor cores 106-109. However, persons of ordinary skill in the art having benefit of the present disclosure should appreciate that the number of processor cores in the CPU 105 is a matter of design choice. Some embodiments of the CPU 105 may include more or fewer than the four processor cores 106-109 shown in FIG. 1.

The processing system 100 includes an input/output engine 120 for handling input or output operations associated with elements of the processing system such as keyboards, mice, printers, external disks, and the like. A graphics processing unit (GPU) 125 is included in the processing system 100 for creating visual images intended for output to a display. Some embodiments of the GPU 125 may include multiple processor cores that are not shown in FIG. 1 interest of clarity.

The processing system 100 shown in FIG. 1 also includes direct memory access (DMA) logic 130 for generating addresses and initiating memory read or write cycles. The CPU 105 may initiate transfers between memory elements in the processing device 100 such as DRAM memory (not shown) or other entities connected to the DMA logic 130 including the CPU 105, the I/O engine 120 and the GPU 125. Some embodiments of the DMA logic 130 may also be used for memory-to-memory data transfer or transferring data between the processor cores 106-109. The CPU 105 can perform other operations concurrently with the data transfers being performed by the DMA logic 130 which may provide an interrupt to the CPU 105 to indicate that the transfer is complete.

Power may be supplied to components in the processing device 100 by a DC power supply 110 or an AC power supply 115. Some embodiments may preferentially operate in an AC mode so that the components of the processing device 100 receive power supplied by the AC power supply 115 when available, e.g., when the AC power supply 115 is receiving power from an external source such as a wall outlet. The processing device 100 may transition to a DC mode when power is not available from the AC power supply 115. In the DC mode, the processing device 100 receives power from the DC power supply 110, e.g., from an internal or external battery associated with the processing device 100. Techniques for selectively coupling the DC power supply 110 or the AC power supply 115 are known in the art. In the interest of clarity, logic and circuitry for selectively coupling the DC power supply 110 or the AC power supply 115 to the components in the processing device 100 are not shown in FIG. 1.

Processing units in the processing device 100 such as the CPU 105, the GPU 125, or the processor cores 106-109 may be operated in different power management states. Examples of power management states include an active state in which a processing unit is performing tasks or executing instructions, an idle state in which the processing unit is not performing tasks or executing instructions, or a power-gated state in which power supplied to the processing device is gated so that no current is supplied to the processing unit, thereby reducing stand-by and leakage power consumption. The processing device 100 may therefore conserve power by idling one or more processing units when there are no instructions to be executed by the processing unit(s). If the processing unit is idle for a relatively long time, power supplied to the processing unit may then be gated so that no current is supplied to the component, thereby reducing stand-by and leakage power consumption.

Performance of the processing units may also be enhanced by boosting the processing units. As used herein, the term “boosting” refers to increasing the operating point of a processing unit, e.g., by increasing the operating voltage or operating frequency of the processing unit. For example, the CPU 105 may be boosted by increasing the voltage supplied to the CPU 105 by the DC power supply 110 (when operating in the DC mode) or the AC power supply 115 (when operating in the AC mode) from a nominal voltage supplied to the processing unit while it is in the active power management state to a boost voltage that is higher than the nominal voltage. Processing units may also be “de-boosted,” e.g. by reducing the voltage supplied to the processing unit from the boost voltage to the nominal voltage.

The processing system 100 shown in FIG. 1 includes boost logic 135 for determining whether one or more of the processing units should be boosted. Some embodiments of the boost logic 135 may determine that one or more of the processing units is to be boosted by increasing the operating point of the processing unit in response to a new user activity being initiated at the processing unit. The boost logic 135 may therefore monitor signals generated in the processing device 100 to detect a new user activity. For example, the boost logic 135 may detect a new user activity on a processing unit in response to the processing unit transitioning from an idle or power gated power management state to the active state. For another example, the boost logic 135 may determine that a new user activity has been initiated in response to a notification generated by an operating system (OS) 140 that indicates the new user activity. For yet another example, the boost logic 135 may determine that a new user activity has been initiated in response to a change in a context associated with a display driver implemented in the CPU 105, the GPU 125, or the I/O engine 120.

Background processes can cause one or more processing units to transition between the active state and the idle state. For example, a background process may issue an interrupt that causes a processing unit to transition from an idle state to an active state to perform a task associated with the background process before returning to the idle state. These transitions do not correspond to a new user activity. The boost logic 135 may therefore implement filters so that transitions caused by interrupts generated by background processes do not result in boosting of one or more processing units. In some embodiments, background processes may generate interrupts relatively frequently (e.g., as compared to the rate at which new user activities are initiated). The boost logic 135 may therefore filter out idle-to-active transitions that occur more frequently than a threshold frequency that corresponds to the frequency at which background processes generate interrupts. A background process may also generate interrupts periodically and some embodiments of the boost logic 135 may filter out periodic transitions that occur at a predetermined frequency or periodicity.

The boost logic 135 may also determine the duration of a boost interval during which one or more of the processing units are boosted. The boost interval may be predetermined or dynamically determined so that the duration of the boost interval is known prior to boosting the processing unit(s). For example, the boost interval may be varied depending on whether the processing device 100 is operating in the DC mode or the AC mode. Some embodiments of the boost logic 135 may provide signaling to the DC power supply 110, the AC power supply 115, or power control circuitry (not shown) to indicate that the operating voltage should be increased to boost one or more processing units or decreased once the boost interval has elapsed.

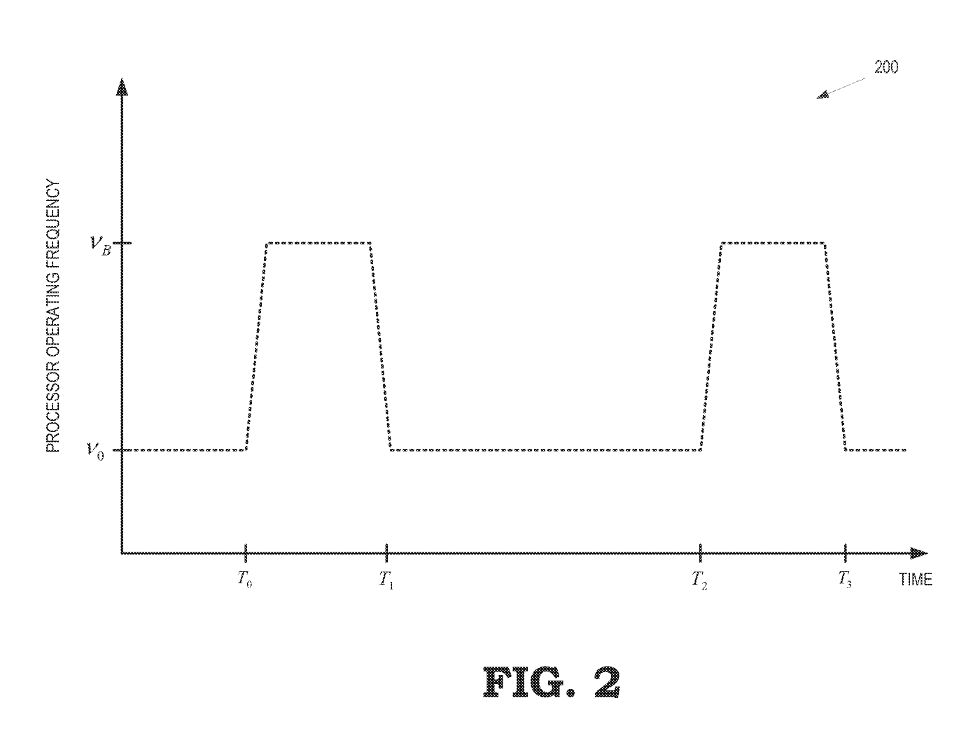

FIG. 2 is a plot 200 of an operating frequency of a processing unit as a function of time according to some embodiments. The vertical axis indicates the processor operating frequency and the horizontal axis indicates time increasing from left to right. The processing unit may be a CPU such as the CPU 105, a processor core such as one of the processor cores 106-109, or a GPU such as the GPU 125 shown in FIG. 1. The operating frequency may be determined by boost logic such as the boost logic 135 shown in FIG. 1. In some embodiments, the operating frequency may be varied by varying the operating voltage that is applied to the processing unit by a power supply such as the DC power supply 110 or the AC power supply 115 shown in FIG. 1. At times T<T₀, the processing unit is operating at a nominal operating frequency v₀, that may correspond to a nominal operating voltage. The boost logic detects a new user activity at time T₀ and provides signaling to boost the operating frequency to a boosted operating frequency v_{B} that is higher than the nominal operating frequency, v₀. For example, the boost logic may instruct the power supply (or related circuitry) to increase the voltage supplied to the processing unit to boost its operating frequency.

The operating frequency remains at the boosted operating frequency v_{B} until a boost time interval has elapsed at time T₁. The boost time interval may be predetermined or may be determined dynamically, as discussed herein. In response to the boost time interval elapsing, the boost logic provides signaling to reduce the operating frequency to the nominal operating frequency v₀. For example, the boost logic may instruct the power supply (or related circuitry) to decrease the voltage supplied to the processing unit to reduce its operating frequency. The processing unit may continue to operate at the nominal operating frequency v₀ until the boost logic detects another new user activity at time T₂ and provides signaling to boost the operating frequency to the boosted operating frequency, v_{B}. The operating frequency remains at the boosted operating frequency v_{B} until a boost time interval has elapsed at time T₃ and the boost logic provides signaling to reduce the operating frequency back to the nominal operating frequency v₀.

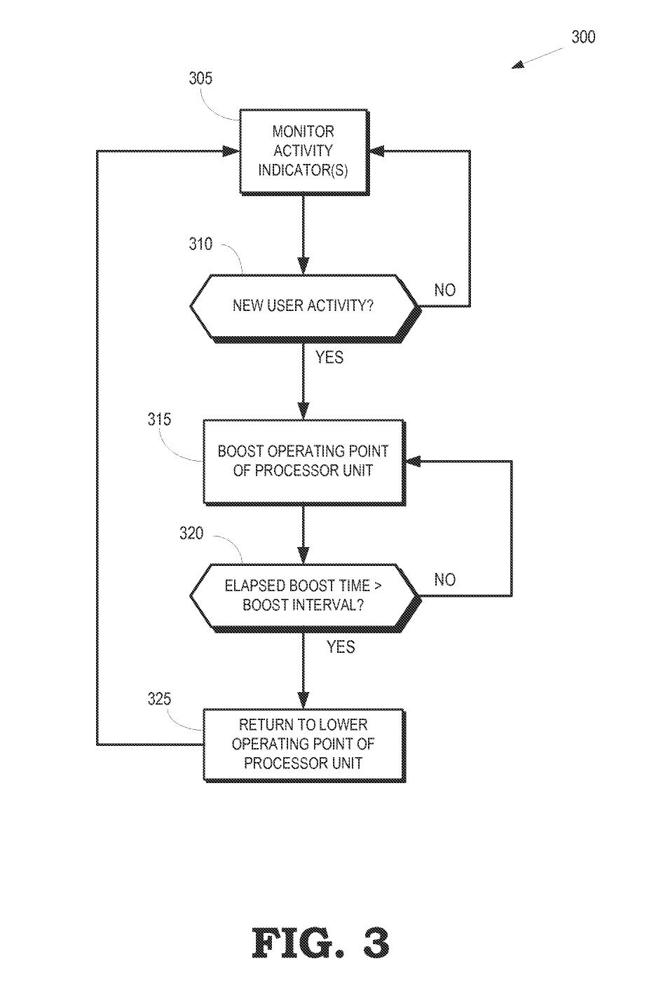

FIG. 3 is a flow diagram of a method 300 for boosting a processing unit during a predetermined boost time interval according to some embodiments. Some embodiments of the method 300 may be implemented in the boost logic 135 shown in FIG. 1. At block 305, the boost logic monitors one or more activity indicators associated with processing units such as the CPU 105, the processor cores 106-109, or the GPU 125 shown in FIG. 1. Examples of activity indicators include information indicating a power management state of the processing units, operating system notifications that indicate that new processes have been initiated, changes in graphics contexts, and the like. At decision block 310, the boost logic determines whether the activity indicators indicate that a new user activity has been initiated by the processing unit. If not, the boost logic continues to monitor the activity indicators at block 305. If the boost logic determines that a new user activity has been initiated by the processing unit, the boost logic causes the operating point of the processing unit to be boosted at block 315, e.g., by increasing the operating voltage or operating frequency of the processing unit.

At decision block 320, the boost logic monitors the elapsed boost time and determines whether the elapsed boost time has exceeded the predetermined boost time interval. If not, the boost logic maintains the operating point of the processing unit at the boosted operating point. Once the elapsed boost time exceeds the predetermined boost time interval, the boost logic causes the operating point of the processing unit to be reduced (at block 325) to a lower operating point such as the nominal operating frequency or nominal operating voltage of the processing unit. In some embodiments, the predetermined boost time interval is set to a value that balances competing demands for increased perceived performance levels and reduced power consumption.

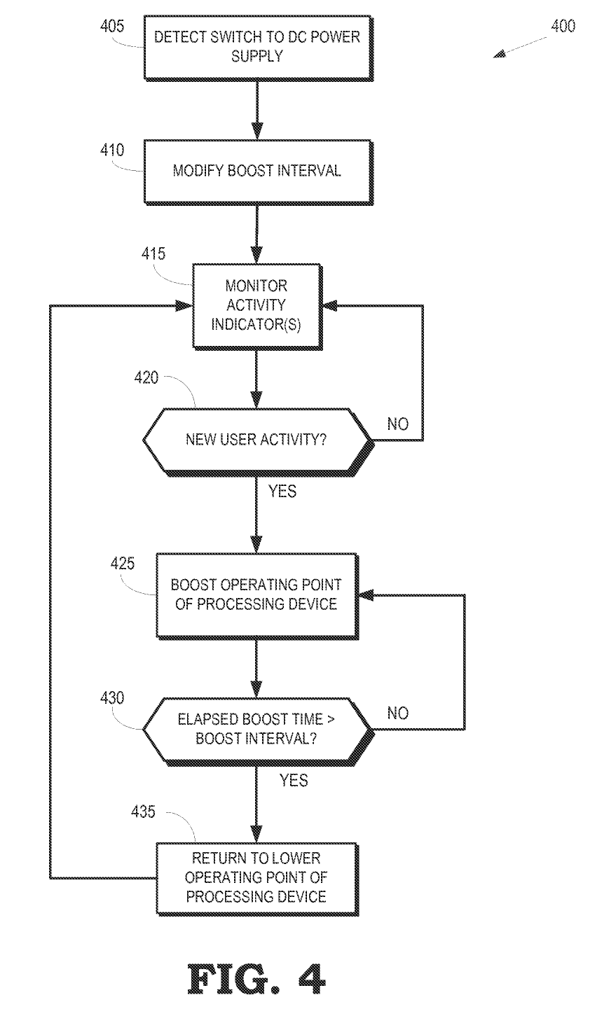

FIG. 4 is a flow diagram of a method 400 for boosting a processing unit during a dynamically determined boost time interval according to some embodiments. Some embodiments of the method 400 may be implemented in the boost logic 135 shown in FIG. 1 and may be used to control processing units such as the CPU 105, the processor cores 106-109, or the GPU 125 shown in FIG. 1. The processing device that includes the processing units operates in an AC mode or a DC mode depending on the availability of AC power. Initially, the processing device is operating on AC mode, e.g., because the processing device is plugged into a wall socket.

At block 405, the boost logic detects a switch from AC mode to DC mode. For example, the processing device may be unplugged from the wall socket so that AC power becomes unavailable. Power control circuitry may therefore switch the operating mode of the processing device from the AC mode to the DC mode. The boost logic may detect signaling generated by the power control circuitry (or other logic) that indicates that the switch has occurred.

At block 410, the boost logic modifies the boost time interval. For example, the boost time interval may be increased from a default time interval to a longer time interval when the processing device is operating in AC mode to prioritize improving the perceived performance of the processing device over power consumption. In response to the operating mode changing to the DC mode, the boost logic may decrease the boost time interval to a relatively short interval (compared to the interval used in the AC mode) so that battery life impact due to boosting is reduced. Varying the boost time interval may therefore be used to achieve the optimal balance between battery life and performance enhancement at the start of a new activity. Some embodiments may also vary the boost time interval in response to changes in the applications are tasks being performed by the processing unit. For example, the boost time interval may be increased or decreased for applications that are expected to take relatively longer or shorter times to perform particular actions.

At block 415, the boost logic monitors one or more activity indicators associated with the processing units. At decision block 420, the boost logic determines whether the activity indicators indicate that a new user activity has been initiated by the processing unit. If not, the boost logic continues to monitor the activity indicators at block 415. If the boost logic determines that a new user activity has been initiated by the processing unit, the boost logic causes the operating point of the processing unit to be boosted at block 425, e.g., by increasing the operating voltage or operating frequency of the processing unit.

At decision block 430, the boost logic monitors the elapsed boost time and determines whether the elapsed boost time has exceeded the dynamically determined boost time interval. If not, the boost logic maintains the operating point of the processing unit at the boosted operating point. Once the elapsed boost time exceeds the dynamically determined boost time interval, the boost logic causes the operating point of the processing unit to be reduced (at block 435) to a lower operating point such as the nominal operating frequency or nominal operating voltage of the processing unit.

In some embodiments, the apparatus and techniques described above are implemented in a system comprising one or more integrated circuit (IC) devices (also referred to as integrated circuit packages or microchips), such as the boost logic described above with reference to FIGS. 1-4. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

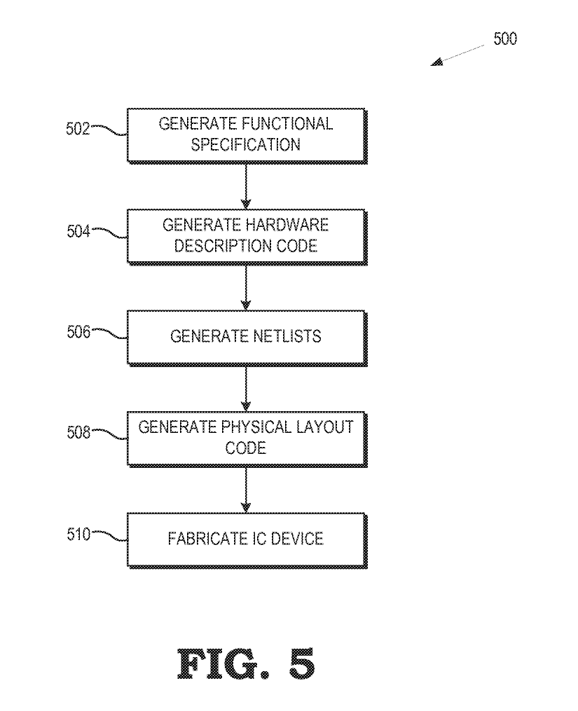

FIG. 5 is a flow diagram illustrating an example method 500 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 502 a functional specification for the IC device is generated. The functional specification (often referred to as a micro architecture specification (MAS)) may be represented by any of a variety of programming languages or modeling languages, including C, C++, SystemC, Simulink, or MATLAB.

At block 504, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 506 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 508, one or more EDA tools use the netlists produced at block 506 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 510, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
increasing an operating point of an active processing unit in response to a user activity at the processing unit, wherein the operating point of the active processing unit is determined by at least one of an operating voltage and an operating frequency; and
returning the operating point to a previous level in response to a time interval elapsing.

2. The method of claim 1, further comprising:
determining the time interval prior to increasing the operating point of the active processing unit.

3. The method of claim 1, further comprising:
modifying the time interval responsive to at least one of a change in a power supply for the processing unit and a change in an application executing on the processing unit.

4. The method of claim 3, wherein setting the time interval comprises reducing the time interval from a default time interval in response to detecting the change.

5. The method of claim 1, further comprising:
determining that the user activity has been initiated based on the processing unit transitioning from an idle state to an active state.

6. The method of claim 5, further comprising:
filtering transitions of the processing unit from the idle state to the active state that occur more frequently than a threshold frequency to prevent transitions at a frequency greater than the threshold frequency from being used to determine that the user activity has been initiated.

7. The method of claim 1, further comprising:
determining that the user activity has been initiated in response to a notification generated by an operating system that indicates the user activity.

8. The method of claim 1, further comprising:
determining that the user activity has been initiated in response to a change in a context associated with a display driver.

9. An apparatus comprising:
at least one processing unit; and
boost logic to increase an operating point of the processing unit when the processing unit is in an active mode in response to a user activity at the processing unit, wherein the operating point of the processing unit is determined by at least one of an operating voltage and an operating frequency and return the operating point of the processing unit to a previous level in response to a time interval elapsing.

10. The apparatus of claim 9, wherein the boost logic is to increase the operating point of the processing unit from a first value to a second value for the time interval and return the operating frequency or operating voltage of the processing unit to the first value in response to the time interval elapsing.

11. The apparatus of claim 10, wherein the boost logic is to set the time interval in response to a change in at least one of a power supply that supplies power to the processing unit and an application executing on the processing unit.

12. The apparatus of claim 11, wherein the boost logic is to reduce the time interval from a default value in response to the switch.

13. The apparatus of claim 9, wherein the boost logic is to determine that the user activity has been initiated in response to the processing unit transitioning from an idle state to an active state.

14. The apparatus of claim 13, wherein the boost logic is to filter transitions of the processing unit from the idle state to the active state that occur more frequently than a threshold frequency to prevent transitions at a frequency greater than the threshold frequency from being used to determine that the user activity has been initiated.

15. The apparatus of claim 9, wherein the boost logic is to determine that the user activity has been initiated in response to a notification generated by an operating system that indicates the user activity.

16. The apparatus of claim 9, wherein the boost logic is to determine that the user activity has been initiated in response to a change in a context associated with a display driver.

17. A non-transitory computer readable medium embodying a set of executable instructions, the set of executable instructions to manipulate an active processing unit to:
increase an operating point of the processing unit when the processing unit is in an active mode in response to a user activity at the processing unit, wherein the operating point of the processing unit is determined by at least one of an operating voltage and an operating frequency; and
return the operating point of the processing unit to a previous level in response to a time interval elapsing.

18. The non-transitory computer readable medium of claim 17, wherein the set of executable instructions is to manipulate the processing unit to increase the operating point of the processing unit from a first value to a second value for the time interval and return the operating frequency or operating voltage of the processing unit to the first value in response to the time interval elapsing.

19. The non-transitory computer readable medium of claim 17, wherein the set of executable instructions is to manipulate the processing unit to set the time interval in response to at least one in a change in a power supply that supplies power to the processing unit and a change in an application executing on the processing unit.

20. The non-transitory computer readable medium of claim 17, wherein the set of executable instructions is to manipulate said at least one processor to determine that the user activity has been initiated in response to at least one of: the processing unit transitioning from an idle state to an active state; a notification generated by an operating system that indicates the user activity; and a change in a context associated with a display driver.
